(19) United States
(12) Patent Application Publication
(10) Pub. No.: US 2017/0332799 A1
(43) Pub. Date: Nov. 23, 2017

(54) ELECTRIC MOTOR DUAL DRIVE

(71) Applicant: de Werth Group AG, Zurich (CH)

(72) Inventor: Eckhart DEWERT, Goldingen (CH)

(21) Appl. No.: 15/581,298

(22) Filed: Apr. 28, 2017

(30) Foreign Application Priority Data
Apr. 29, 2016 (DE) 10 2016 108 033.0
Jul. 28, 2016 (DE) 10 2016 113 980.7
Aug. 31, 2016 (DE) 10 2016 116 250.7

(51) Int. Cl. A47C 20/04; A61G 7/018; A47C 17/175; A61G 7/015; A47C 19/00

(52) U.S. Cl. CPC A47C 20/041; A61G 7/018; A47C 17/1756; A47C 19/005; A61G 7/015

(57) ABSTRACT

Electric motor dual drive for an adjustable support device for supporting a box spring mattress or an upholstered bed, which includes a frame and plate-like supporting parts pivotably adjustable relative to one another, and includes a fixed central supporting part, one end of which is articulatedly connected to an upper body supporting part pivotably connected around a horizontal pivoting axis. The other end of which is articulatedly connected to a leg supporting part pivotably connected around a horizontal pivoting axis. Dual drive includes a base on which two drive units are arranged. Each drive unit is drive-couple connected in the installation position of the dual drive with a pivot lever. The pivot levers are attached pivot-mounted to the base and disposed in operative connection with an adjustable supporting part to adjust the same supporting part and the dual drive is formed for toolless installation on support device.

### CROSS-REFERENCE TO RELATED APPLICATION

This application claims the priority of German application nos. DE 10 2016 108 033.0, filed Apr. 29, 2016; DE 10 2016 113 980.7, filed Jul. 28, 2016; and DE 10 2016 116 250.7, filed Aug. 31, 2016, and each of which is incorporated herein by reference.

### FIELD OF THE INVENTION

The invention relates to an electric motor dual drive for adjusting supporting parts, pivot-mounted relative to one another, of a support device to support a box spring mattress or an upholstered bed relative to one another.

### BACKGROUND OF THE INVENTION

Dual drives are generally known, for example, for use with slatted frames. They comprise a base unit, which can be formed specifically as a casing and on or in which two drive units are arranged, each comprising an output member that interacts in the installation position of the dual drive with a pivot element in the form of a pivot shaft, which is disposed in an operative connection with an adjustable supporting part to pivot the same. The pivot shaft is part of an adjustment fitting being part of an adjustable support device, for example a slatted frame. The output member is generally formed by a linear moving spindle nut in the known furniture drives. To implement the linear movement of the spindle nut in a pivoting movement of the pivot shaft, a link lever is non-rotatably fitted to the pivot shaft. To adjust a supporting part of the support device, the spindle nut presses against the link lever such that the pivot shaft pivots and the supporting part are thereby shifted in the desired manner.

### OBJECTS AND SUMMARY OF THE INVENTION

An object of the invention is to specify an electric motor dual drive, with which the installation on the support device is simplified.

The invention provides a dual drive, which is formed for toolless installation on a support device for a box spring mattress or upholstered bed. In this way, the installation of the dual drive on the support device is simply designed and can be performed quickly.

As per the invention, during the installation of the dual drive, the relevant pivot lever can be attached to the allocated supporting part, for example screwed to the supporting part. To further simplify the installation, an advantageous further embodiment of the invention provides that at least one pivot lever of the dual drive impinges loosely on the allocated supporting part. In this way, attachment to the supporting part is superfluous.

Advantageously, every pivot lever is pivotable by means of an allocated output member to pivot the allocated supporting part, as this is provided in an advantageous further embodiment.

In the aforementioned embodiment, it is advantageous if the output member is linear moving. Appropriate linear drives are available as relatively simple and cost-effective components and are suitable for applying great forces.

A development of the above embodiment provides that the output member is a spindle nut, which is arranged non-rotatably and movable in the axial direction on a fixed threaded spindle, disposed in a rotary drive connection with an electric motor of the drive unit, as an advantageous further embodiment provides this.

In kinematic reversal of the aforementioned embodiment, the output member can however also be threaded spindle, which is movably mounted non-rotatably in its axial direction and on which a fixed spindle nut is arranged, which is disposed in a rotary drive connection with an electric motor of the drive unit.

Appropriate spindle drives are available as relatively simple and cost-effective standard components and are suitable for applying great forces.

The base of the dual drive can be designed in various ways according to the relevant requirements. An advantageous further embodiment of the invention provides in this respect that the base of the dual drive is formed as a casing, preferably made of plastic. Through the casing, the components of the dual drive housed in the casing are protected.

To simplify the manufacture of the casing in the aforementioned embodiment, an advantageous further embodiment provides that the housing consists of two half shells.

Another advantageous further embodiment of the invention provides that supporting elements, that is supports, are formed at the ends of the base, with which the base is positioned on transverse struts of the support device in the installation position of the dual drive. In this way, the installation is designed particularly simply, in which the base is positioned on the struts in a first installation step.

In the aforementioned embodiment, it is essentially possible to attach the supporting elements to the struts. To further simplify the installation, an advantageous further embodiment provides that the supporting elements are positioned loosely on the struts in the installation position of the dual drive. In this way, attachment to the struts is superfluous.

Another advantageous further embodiment of the invention provides a fastening element, such as a fastener, for toolless attachment of the central supporting part to the base of the dual drive.

Hereby, the fastener can, for example, and specifically comprise a toollessly operable screwing device, as another further embodiment provides this.

To further simplify an attachment of the base to the central supporting part of the support device, another advantageous further embodiment provides that fastening straps for the screw attachment of the base to the fixed central supporting part of the support device are preformed on the base or are formed on the base.

An electric motor adjustable support device according to the invention to support a box spring mattress or an upholstered bed includes a dual drive according to the invention set forth herein.

This object is likewise achieved by the invention including an electric motor dual drive for an adjustable support device for supporting a box spring mattress or an upholstered bed, which includes:

a frame and plate-like supporting parts being pivotably adjustable to one another, which comprise at least one fixed central supporting part, with whose one end is connected in an articulated manner and pivotable around a horizontal pivoting axis an upper body supporting part, and with whose other end is connected in an articulated manner and around a horizontal pivoting axis a leg supporting part;

the dual drive including a base, on which two drive units are arranged, each drive unit is drive-couple connected in the installation position of the dual drive with a pivot lever;

the pivot levers being attached pivot-mounted to the base and are disposed in an operative connection with an adjustable supporting part to adjust the same supporting part; and

the dual drive being formed for toolless installation on the support device.

The invention is explained in more detail below referencing the attached schematic drawing, in which embodiments of a dual drive according to the invention and a support device according to the invention are represented. Thus, all features described in the description, represented in the drawing and claimed in the patent claims form in their own rights and in any suitable combination with one another the subject of the invention, irrespective of their summary in the patent claims, and irrespective of their description, or representation in the drawing.

Relative terms such as left, right, up, and down are for convenience only and are not intended to be limiting.

### BRIEF DESCRIPTION OF THE DRAWINGS

It can be seen that:

FIG. 1 shows a perspective view of an embodiment of an electric motor adjustable support device according to the invention for supporting a box spring mattress with a first embodiment, a furniture drive according to the invention in the form of a dual drive, wherein the support device is shown in the end position of the adjusting movement which corresponds to a maximally adjusted position,

FIG. 2 shows in the same representation as FIG. 1 the support device according to FIG. 1, wherein supporting parts of the support device are omitted,

FIG. 3 shows in the same representation as FIG. 2 the support device according to FIG. 2, wherein a frame of the support device is omitted,

FIG. 4 shows a detail from FIG. 3 in an enlarged scale compared to FIG. 3,

FIG. 5 shows in the same representation as FIG. 3 the support device according to FIG. 3, wherein the base being formed as a profile rail of the furniture drive is omitted,

FIG. 6 shows a detail from FIG. 5 in an enlarged scale,

FIG. 7 shows a perspective view of a second embodiment of a dual drive according to the invention, wherein pivot levers of the dual drive are represented in a starting position of the adjusting movement,

FIG. 8 shows in the same representation as FIG. 7 the dual drive according to FIG. 7, wherein the pivot levers are represented in the end position of the adjusting movement,

FIG. 9 shows in the same representation as FIG. 8 the dual drive according to FIG. 8, wherein the half shell of a casing of the dual drive is omitted,

FIG. 10 shows a detail from FIG. 9 in the same representation as FIG. 9, but in an enlarged scale,

FIG. 11 shows in the same representation as FIG. 10 the dual drive according to FIG. 10, wherein a pressure piece of a drive unit of the dual drive is omitted for reasons of illustration,

FIG. 12 shows the pressure piece taken by itself in the same representation as FIG. 10,

FIG. 13 shows in the same representation as FIG. 9 the dual drive in the starting position of the adjusting movement represented in FIG. 7 and

FIG. 14 shows a detail from FIG. 8 in the same representation as FIG. 8, but in an enlarged scale.

### DETAILED DESCRIPTION OF THE INVENTION

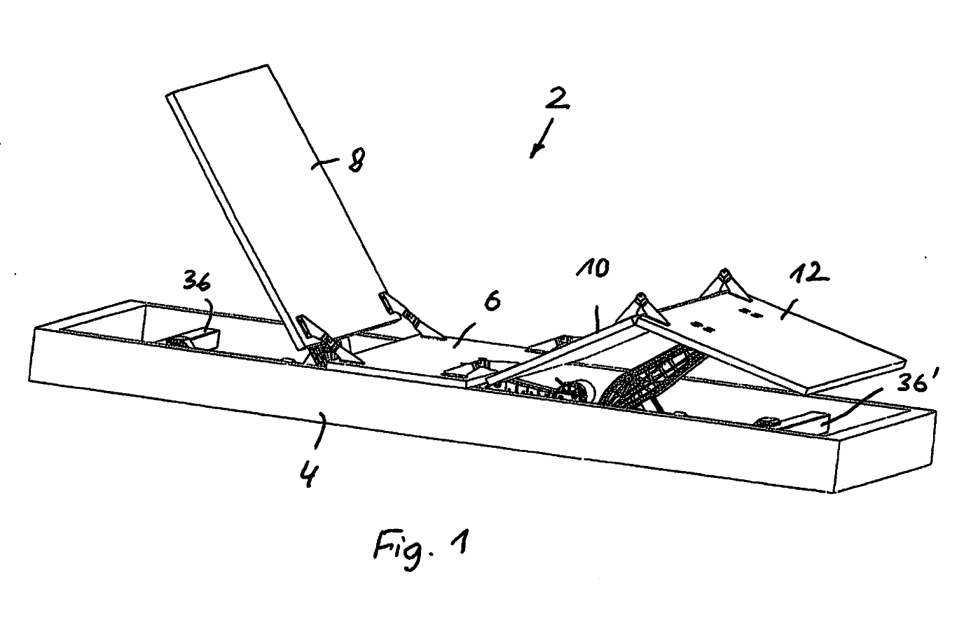

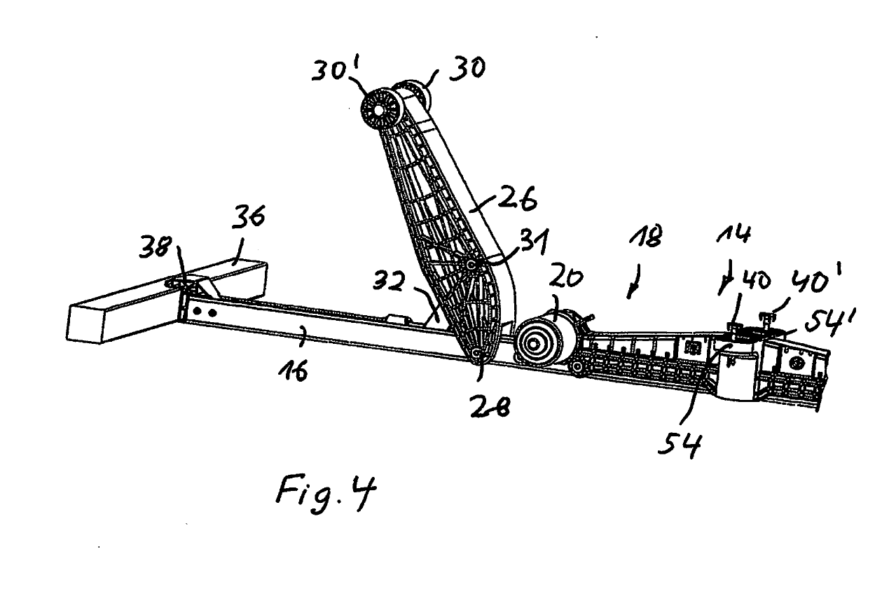

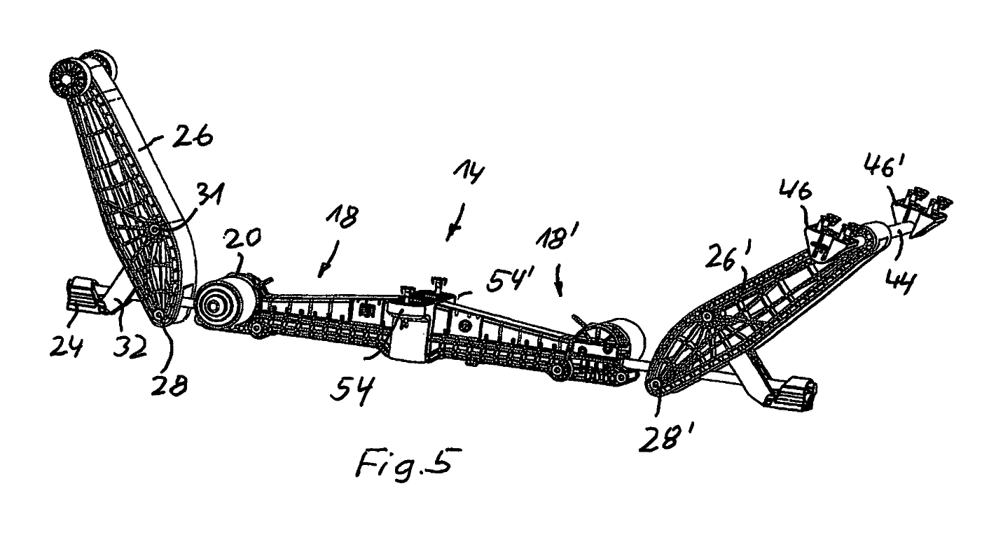

In order to explain an embodiment of an electric motor adjustable support device according to the invention, which is provided with an embodiment of an electric motor dual drive, reference will be made to FIG. 1 to FIG. 6 below.

In FIG. 1, an embodiment of an electric motor adjustable support device 2 according to the invention to support a box spring mattress is represented. The box spring mattress itself is not shown to simplify the representation in the drawing.

The support device 2 comprises a frame 4 and plate-like supporting parts being pivotably adjustable to one another, which comprise a stationary central supporting part 6, with which one end is connected in an articulated manner and pivotable around a horizontal pivoting axis to an upper body supporting part 8. With the end of the central supporting part 6 facing away from the upper body supporting part 8 is connected in an articulated manner and pivotable around a horizontal pivoting axis a leg supporting part 10, on which a calf supporting part 12 is hinged.

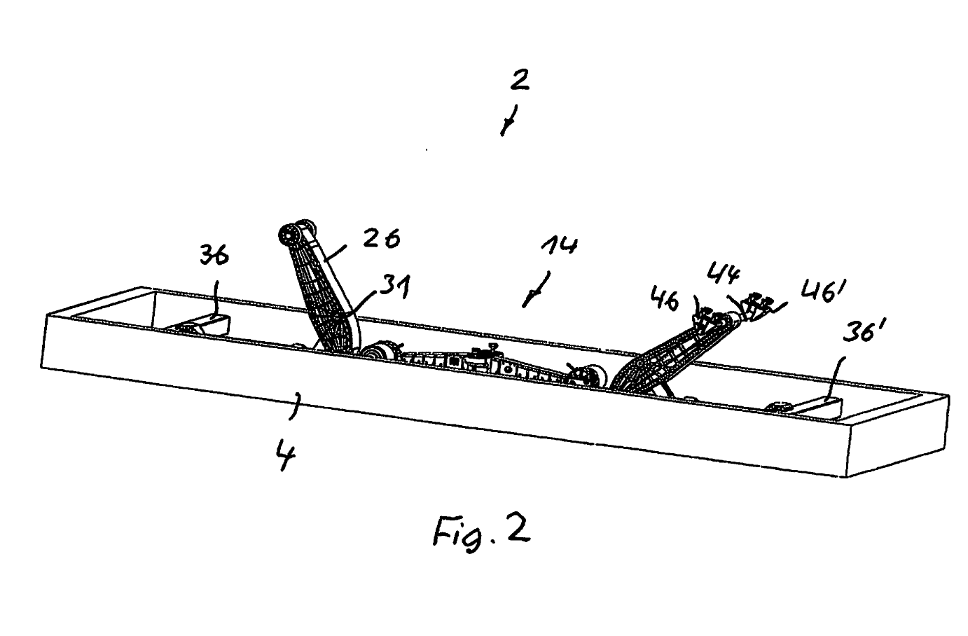

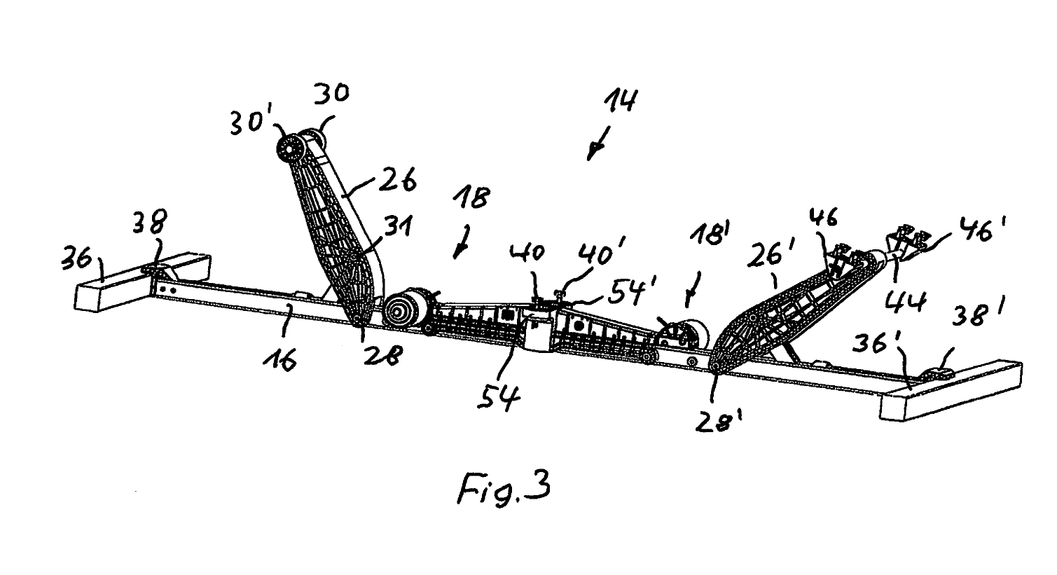

In FIG. 2, the supporting parts 6 to 12 are omitted to simplify the representation. In FIG. 3, the frame 4 of the support device 2 is also omitted.

The structure of an embodiment of a dual drive 14 according to the invention is explained below. The dual drive 14 comprises a base 16, which is formed as a C profile rail in this embodiment. Two drive units 18, 18′ are arranged on the base 16, wherein the drive unit 18 is allocated to the upper body supporting part 8 to adjust the same and the drive unit 18′ is allocated to the leg supporting part 10 and the calf support part 12 to adjust the same. Only the drive unit 18 will be explained in more detail below. The drive unit 18′ is constructed in the same manner and is therefore not further explained here.

The drive unit 18 comprises an electric motor 20, which is disposed in a rotary drive connection by means of a worm gear with a threaded spindle 22, on which non-rotatably and moving linearly in the axial direction of the threaded spindle 22 a spindle nut 24 is arranged, which forms the output member of the drive unit 18. To pivot the upper body supporting part 8 relative to the central supporting part 6, a pivot element in the form of a pivot lever 26 is provided, which is pivot-mounted to the base 16 of the dual drive 14 around a pivoting axis 28. The end of the pivot lever 26 facing away from the pivoting axis 28 bears rollers 30, 30′, on which the upper body supporting part 8 is supported with its side facing away from the box spring mattress, such that the pivot lever 26 loosely impinges on the upper body supporting part 8.

With the pivot lever 26, in an articulated manner at an interval to its end, one end of the setting lever 32 is connected, the other end of which is loosely impinged on by the spindle nut 24.

Based on a starting position of the adjusting movement, which corresponds to a reclined position of the support device 2 and in which the upper body supporting part 8 spans a fundamentally horizontal support plane together with the central supporting part 6 and the leg supporting part 10 as well as the calf supporting part 12, the electric motor 20 actuates the threaded spindle 22 such that the spindle nut 24 in the drawing moves towards the right and presses against the facing end of the setting lever 32, whereby the setting lever 32 is positioned. Thus, the pivot lever 26 in the drawing is pivoted in a clockwise direction such that the upper body supporting part is pivoted in the desired manner.

The resetting from the end position of the adjusting movement being represented in the drawing into the starting position is carried out with an activated electric motor 20, but under the weight force of the upper body supporting part 8 or a person reposing on the support device 2.

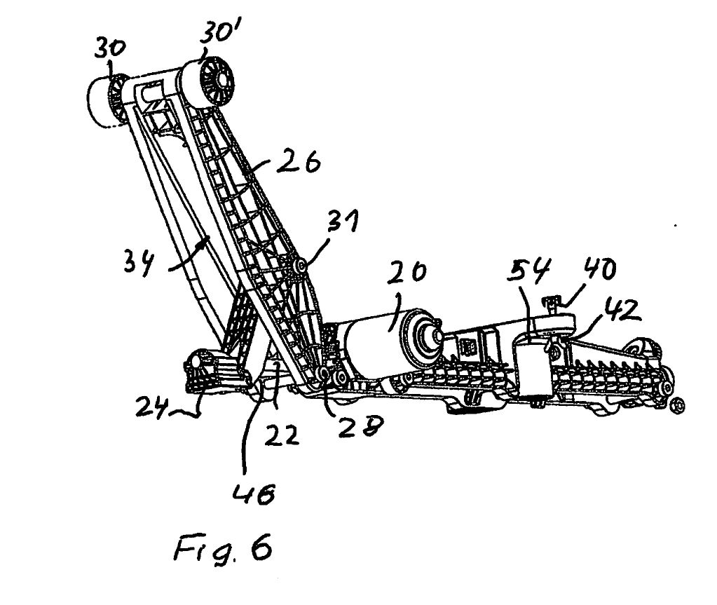

As is visible in FIG. 6, the pivot lever 26 comprises on its side facing the spindle nut 24 and setting lever 32 a recess 34 running in the longitudinal direction of the pivot lever 26, which is such formed that in the starting position of the adjusting movement, in which the upper body supporting part 8 is significantly arranged horizontally, the spindle nut 24 and the setting lever 32 are incorporated into the recess 34.

As a result of the pivot lever 26 being pivot-mounted to the base 16 of the dual drive 14, a separate adjustment fitting becomes superfluous. In this way, a particularly simple structure is produced.

As to the invention, the dual drive 14 is formed for toolless installation on the support device 2. With the represented embodiment, the support device 2 comprises struts 36, 36′ running transversely to its longitudinal direction (see specifically FIG. 2 and FIG. 3). At the end of the profile rail, which forms the base 16 of the dual drive 14, supporting elements 38, 38′ are arranged, with which the base 16 is supported on the struts 36, 36′ in the installation position represented in the drawing of the dual drive 14. According to the relevant requirements, the supporting elements, that is supports, 38, 38′ can be attached to the struts 36, 36′ using a suitable fastener. However, in the represented embodiment, the supports 38, 38′ are laid loosely on the struts 36, 36′. The interval between vertical surfaces of the supporting elements 38, 38′ facing away from one another corresponds substantially to the clear span between the cross struts 36, 36′. If necessary, the dual drive 14 can be lightly clamped between the cross struts 36, 36′.

With the represented embodiment, a further fastener is provided for the toolless fastening of the central supporting part 6 to the base 16 of the dual drive 14, which comprise a toolless, hand-operated screwing device in this embodiment. The screwing device comprises in the represented embodiment in the sense of a toolless attachment are winged screws, of which only one winged screw 42 is visible in FIG. 6. The winged screws can be screwed into the nuts 40, 40′ being arranged on the central supporting part 6.

To disassemble the dual drive 14, for example, for maintenance purposes, it is only necessary to loosen the winged screws 42, 42′ and to lift the supporting elements 38, 38′ from the struts 36, 36′. The assembly and disassembly of the dual drive 14 are thereby completely toolless and particularly easy to achieve.

The pivot lever 26′ being allocated to the leg supporting part 10 and the calf supporting part 12 bears at its ends an axis 44 (see FIG. 3) running parallel to the pivoting axis of the pivot lever 26′, the axis being incorporated in the installation position of the dual drive 14 into receptacles 46, 46′, which are attached to the underside of the calf supporting part 12. In this way, the leg supporting part 10 and the calf supporting part 14 are adjusted when pivoting the pivot lever 26.

A method for the emergency lowering of a supporting part being adjusted by a furniture drive according to the invention also has independent inventive significance. If, for example, the electricity cuts out in the adjusting position being shown represented in FIG. 6 of the pivot lever 26 and thereby of the upper body supporting part 8, the pivot lever 26 can be moved manually in a clockwise direction in FIG. 6 such that the setting lever 32 is disengaged from the spindle nut 24 and the pivot lever 26 is thereby decoupled from the traction train of the drive unit 18. Subsequently, the pivot lever 26 in the drawing can be moved in a counter-clockwise direction, wherein the upper body supporting part moves back into the starting position and the setting lever 32 glides to the left through the spindle nut 24 in the drawing. In the starting position of the adjusting movement being re-achieved at the end of this movement, the setting lever 32 and the spindle nut 24 are incorporated into the recess 34 of the pivot lever 26.

To move the pivot lever 26 back into drive connection with the traction train of the drive unit 18, it is only necessary to control the electric motor 20 such that the spindle nut 24 in the drawing moves back into its starting position towards the left. It thereby underpins the setting lever 32 such that this moves over the spindle nut 24 and reengages with the end of the spindle nut 24 facing towards the electric motor 20 thereby re-establishing the drive connection. To make this procedure easier, the setting lever 32 can be fitted on the underside of its free end with a run-in slope 46 as shown in FIG. 6. The emergency lowering is thereby particularly easily designed.

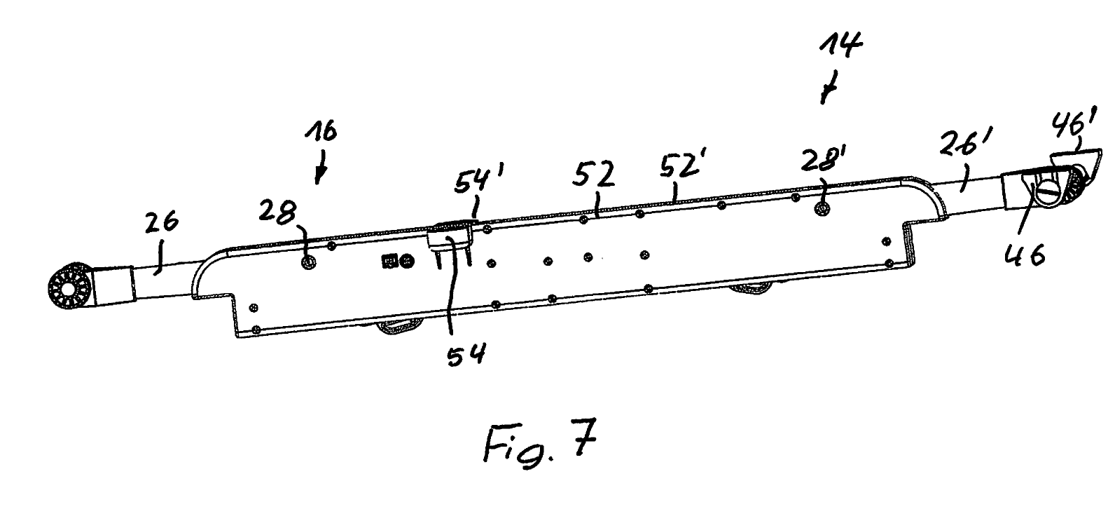

To explain a second embodiment of a furniture drive according to the invention, reference is made to FIGS. 7 to 14 below.

In FIG. 7, a second embodiment of a dual drive 14 according to the invention is represented, at the base 16 of which in conformity with the first embodiment pivot elements are each attached pivot-mounted in the form of pivot levers 26, 26 around a pivoting axis 28, 28′. In further conformity with the first embodiment, the dual drive 14 is formed for toolless installation on a support device for a box spring mattress or upholstered bed, as was explained for the first embodiment. FIG. 7 shows the dual drive 14 in a starting position of the adjusting movement with a position of the pivot levers 26, 26 conforming to an adjusting position of the support device, in which the supporting parts span a substantially horizontal support plane.

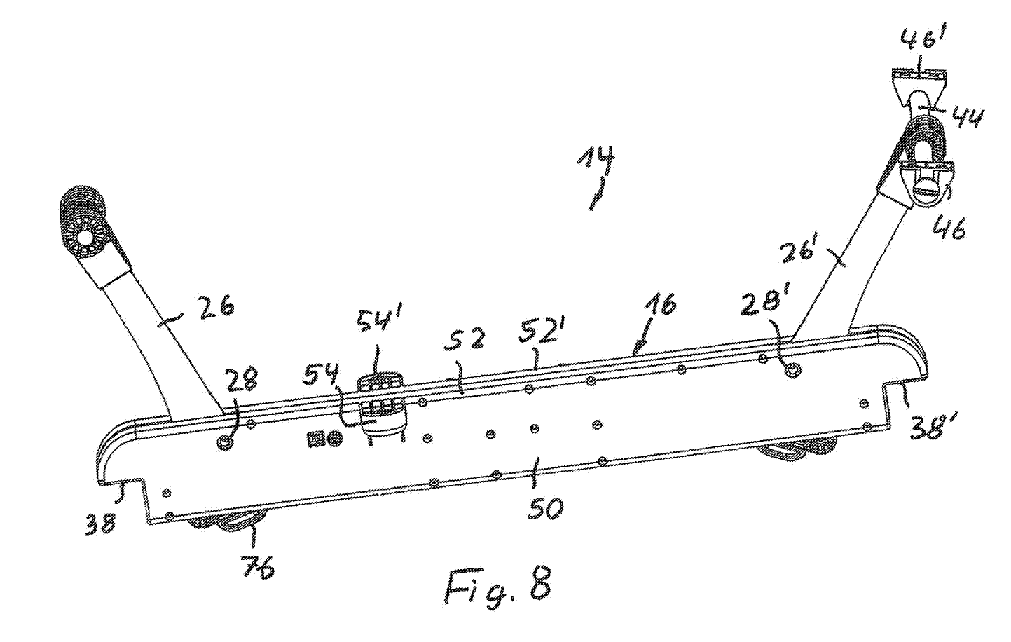

FIG. 8 shows the dual drive according to FIG. 7 in a position of the pivot lever 26, 26′ corresponding to an end position of the adjusting movement, in which the supporting parts are maximally adjusted relative to each other.

The second embodiment differs initially from the first embodiment thus that the base 16 is formed as a casing 50, into which the drive units being allocated to the pivot levers 26, 26′ are incorporated. The casing 50 consists in the represented embodiment of two half shells 52, 52′ made of plastic. The half shells 52, 52′ are connected with screws to one another or can be connected with screws to one another.

On the ends of the casing 50 being located in the longitudinal direction, supporting elements 38, 38′ are formed in the casing, with which the dual drive 14 is positioned in the installation position on transverse struts of a support device and is supported on these (see the reference numeral 36, 36′ in FIG. 3).

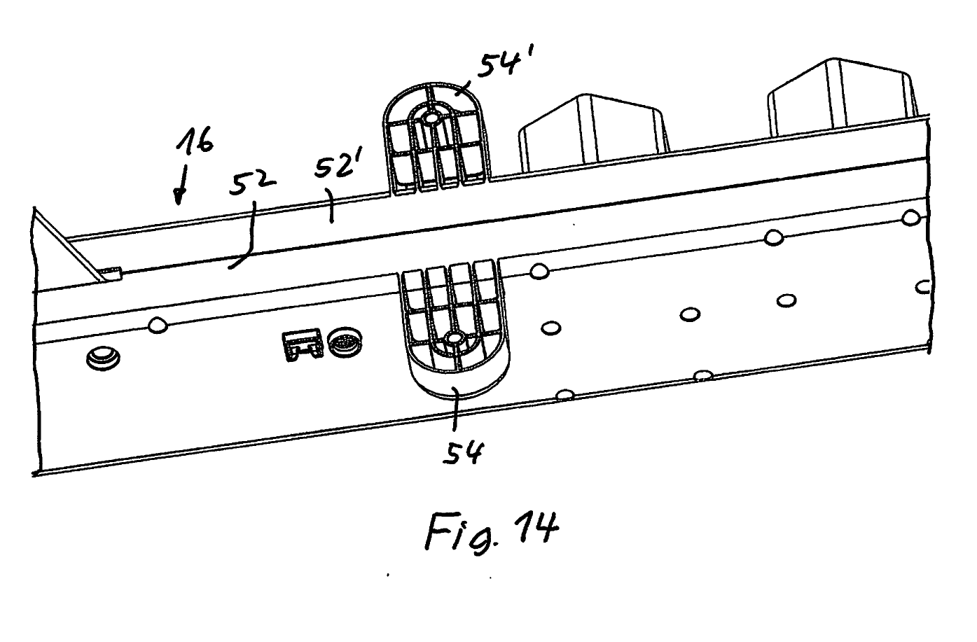

For attachment to a fixed central supporting part of a support device, fastening straps 54, 54′ are fitted on the half shell 52, 52′, as shown in FIG. 8 and particularly well in FIG. 14.

The installation of the dual drive 14 on a support device is principally executed in the same way as is explained in the first embodiment. For this purpose, the dual drive 14 is positioned on the transverse struts of the support device by means of supporting elements 38, 38′. Subsequently, the dual drive 14 can be screwed by means of the fastening straps 54, 54′ with its casing to a fixed central supporting part of a support device. The screwing can specifically be produced using a toollessly operable screwing device.

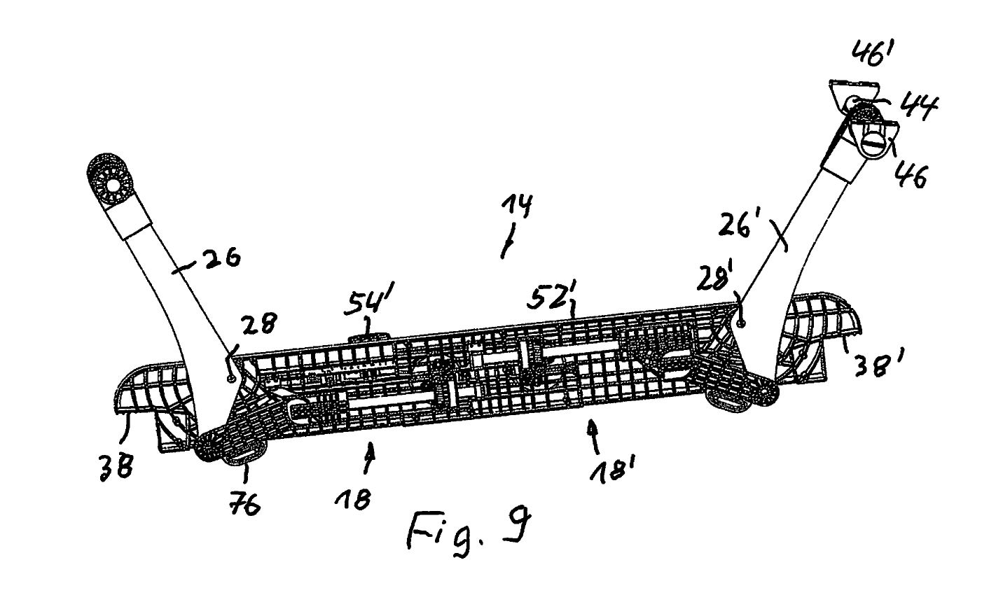

On the basis of FIGS. 9 to 12, the drive units 18, 18′ of the dual drive 14 are explained in detail below.

FIG. 9 shows the dual drive 14 in the adjusting position according to FIG. 1, wherein for reasons of explanation of the structure of the drive units 18, 18′ the half shell 52 of the casing 16 is omitted. Only the drive unit 18 will be explained in more detail below, the drive unit 18′ is constructed in the same manner and is therefore not further explained.

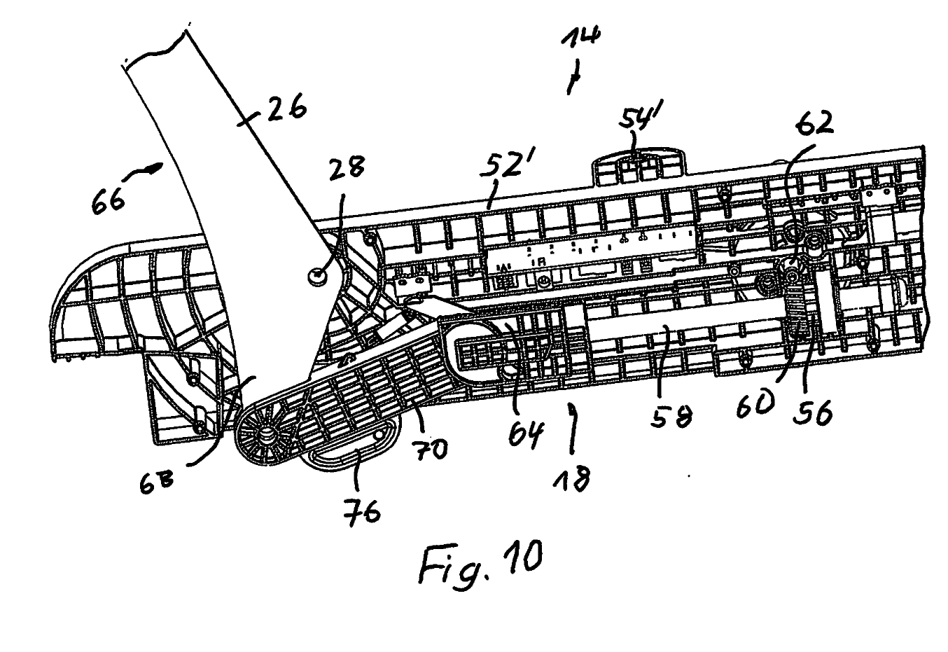

The drive unit 18 comprises a fixed spindle nut 56 being rotatably mounted in the casing 16, the spindle nut being attached to a threaded spindle 58 being non-rotatably mounted in the casing 16 and movable in its axial direction. With the spindle nut 56 a screw wheel 60 is non-rotatably connected, which is engaged with a worm 62, which is engaged with a driveshaft of an electric motor of the drive unit 18 such that the threaded spindle 58 moves left or right according to the rotational direction of the driveshaft of the electric motor in FIG. 10.

For the power supply and control of the drive units 18, 18′, power supply and control means not represented in the drawing are provided, whose basic structure is however generally known to the person skilled in the art and is therefore not explained in detail here.

A pressure piece 64 is fitted to the end of the threaded spindle 58 facing the pivoting axis 28.

Departing from the first embodiment, the pivot lever 26 of the second embodiment is embodied as a two-armed lever, whose first lever arm 66 loosely impinges on the allocated adjustable supporting part and whose second lever arm 68 is disposed in a drive connection with the drive element being formed by the pressure piece 64 of the drive unit 18.

A strap 70 is arranged between the second lever arm 68 and the pressure piece 64 of the drive unit 18, whose first end disconnected from the pivoting axis 28 is connected in an articulated manner with the second lever arm 68 and whose second end can be pressurized by the pressure piece 64 or is pressurized during the adjusting movement. In the represented embodiment, the pressure piece applies the second end of the strap 70 loosely using an engaging surface.

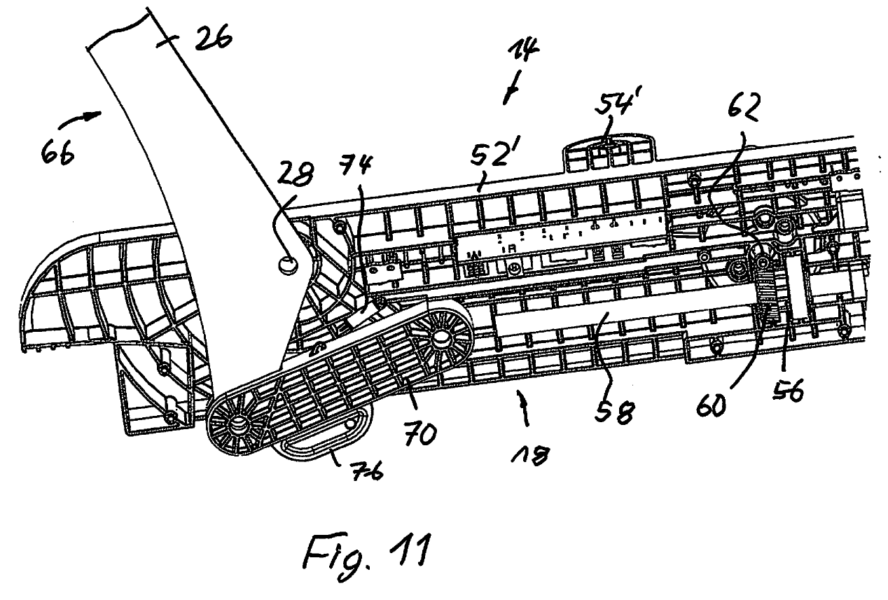

FIG. 11 shows the drive unit 18, wherein the pressure piece 64 is omitted for reasons of explanation.

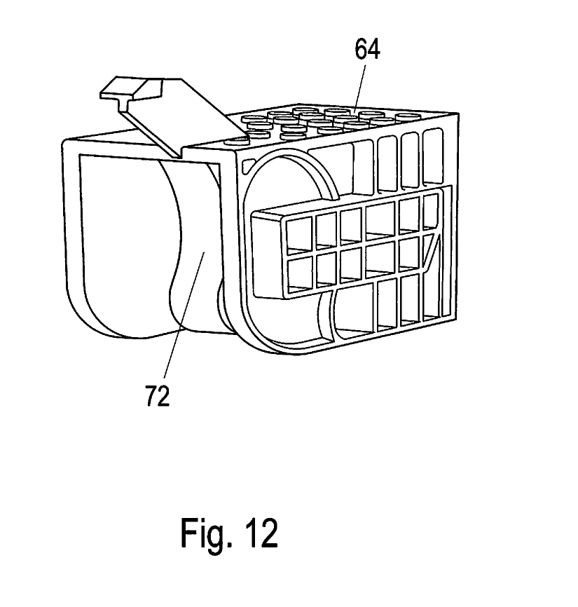

FIG. 12 shows the pressure piece 64 in itself, wherein an engaging surface 72 of the pressure piece 64 is specifically visible.

From FIG. 11 and FIG. 12 as well as a comparison of FIG. 11 with FIG. 12, it is visible that the engaging surface 72 and the second end of the strap are profiled in the cross-section and formed in a complementary manner to each other. In the represented embodiment, the engaging surface 64 is formed concavely in the cross-section and the second end of the strap is formed convexly in a correspondingly complementary manner, wherein the engaging surface 72 and the end of the strap 70 are embodied in an arch shape in the cross-section.

To preload the second end of the strap 70 against the engaging surface 72 of the pressure piece 64, spring means are provided, which are formed in this embodiment between an internal wall of the casing 50 and the control spring acting as the strap 70 in the form of a compression spring 74.

To adjust the pivot lever 26 and thereby the allocated supporting part from the starting position represented in FIG. 7 of the adjusting movement in the direction of the end position represented in FIG. 8 of the adjusting movement, the electric motor drives the spindle nut 56 such that the threaded spindle 58 moves towards the left with the pressure piece 64 in FIG. 10. Hereby, the pressure piece 64 presses against the second end of the strap 70. Using the compression spring 74, the second end of the strap 70 is thereby held in engagement with the engaging surface 72. During the movement of the pressure piece 64 in FIG. 10 towards the left, the pivot lever 26 in FIG. 10 pivots in a clockwise direction such that the supporting part impinged upon by the pivot lever 26 is pivoted in the desired manner.

If the electricity goes off in the adjusted support device, the pivot lever 26 can be manually reset as follows with the thereby adjusted supporting part in the sense of an emergency disengagement (emergency lowering):

To execute an emergency lowering, the pivot lever 26 is manually moved in the clockwise direction beyond the end position represented in FIG. 10 of the adjusting movement in FIG. 10, wherein the second end of the strap 70 is disengaged from the engaging surface 72 of the pressure piece 64. The strap 70 is hereby drawn upwards by the compression spring 74.

The strap 70 is provided with a handle element 76 on its lower end, which is accessible through an opening formed in the casing 50, as can be seen in FIG. 8. Using the handle element 76, the strap 70 can be drawn downwards and moved out of the trajectory of the pressure piece 64. Subsequently, the pivot lever with the thereby adjusted supporting part in FIG. 10 can be reset in the anticlockwise direction, wherein the strap 70 moves outside of the casing 50 under the shutdown pressure piece.

To reengage the strap 70 with the engaging surface 72 and to thereby reactivate the drive unit 18, the pivot lever 26 can be manually moved in the clockwise direction in FIG. 10, wherein the strap 70 is reengaged with the engaging surface 72 of the pressure piece 64 under the effect of the compression spring 74.

An emergency lowering is realized in this way, which has an independent inventive significance in itself.

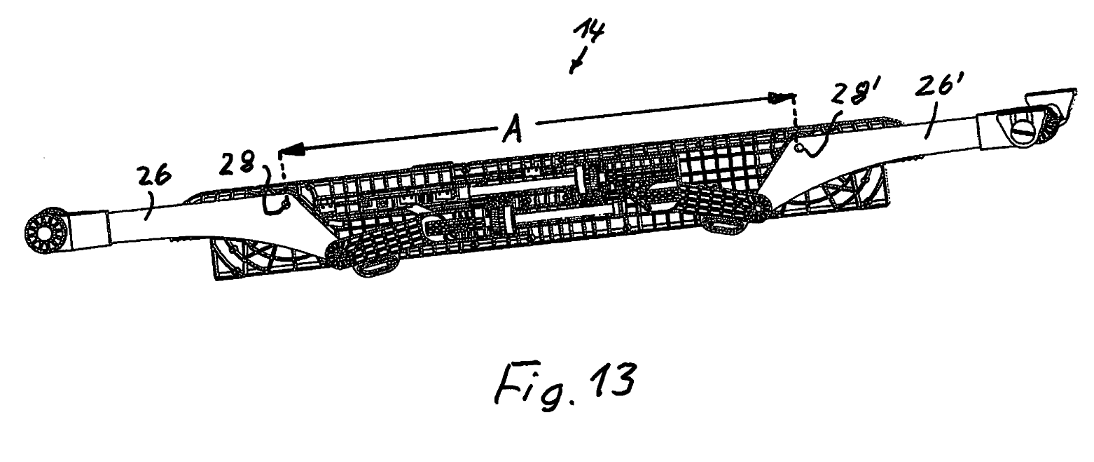

In FIG. 13, the interval between the pivoting axes 28, 28′ is labelled with “A.” According to an embodiment of the invention, which has an independent inventive significance in itself for dual drives of any kind, the interval A is greater than 620 mm. Particularly favorable conditions arise in this way when adjusting supporting parts of a support device.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. An electric motor dual drive for an adjustable support device for supporting a box spring mattress or an upholstered bed, comprising:
a) a frame and plate-like supporting parts being pivotably adjustable to one another, which include at least one fixed central supporting part, with whose one end an upper body supporting part is connected in an articulated manner and pivotable around a horizontal pivoting axis, and with whose other end a leg supporting part is connected in an articulated manner and around a horizontal pivoting axis;
b) the dual drive including a base, on which two drive units are arranged, each drive unit is drive-couple connected in the installation position of the dual drive with a pivot lever;
c) the pivot levers being attached pivot-mounted to the base and are disposed in an operative connection with an adjustable supporting part to adjust the same supporting part; and
d) the dual drive being formed for toolless installation on the support device.

2. The electric motor dual drive according to claim 1, wherein:
a) at least one pivot lever impinges loosely on the allocated supporting part in the installation position of the dual drive.

3. The electric motor dual drive according to claim 1, wherein:
a) each pivot lever is pivotable by an allocated output member to pivot the allocated supporting part.

4. The electric motor dual drive according to claim 3, wherein:
a) the or each output member is linearly movable.

5. The electric motor dual drive according to claim 4, wherein:
a) the output member is a spindle nut, which is arranged non-rotatably and movable in the axial direction on a threaded spindle, disposed in a rotary drive connection with an electric motor of the drive unit.

6. The electric motor dual drive according to claim 4, wherein:
a) the output member is a spindle nut, which is mounted non-rotatably and movable in the axial direction and on which a fixed threaded spindle is arranged, which is disposed in a rotary drive connection with an electric motor of the drive unit.

7. The electric motor dual drive according to claim 1, wherein:
a) the base of the dual drive includes a casing.

8. The electric motor dual drive according to claim 7, wherein:
a) the casing includes two half shells.

9. The electric motor dual drive according to claim 1, wherein:
a) supports are formed at the ends of the base, with which the base is positioned on transverse struts of the support device in the installation position of the dual drive.

10. The electric motor dual drive according to claim 9, wherein:
a) the supports are positioned loosely on the struts in the installation position of the dual drive.

11. The electric motor dual drive according to claim 1, wherein:
a) a fastener is provided for toolless attachment of the central supporting part to the base of the dual drive.

12. The electric motor dual drive according to claim 11, wherein the fastener includes a toolless manually operable screwing device.

13. The electric motor dual drive according to claim 1, wherein:
a) fastening straps are formed on the base for a screw attachment of the base to the fixed central supporting part.

14. The electric motor dual drive according to claim 7, wherein:
a) the casing is made of plastic.

15. The electric motor dual drive according to claim 13, wherein:
a) the fastening straps formed on the base are preformed.

16. An electric motor adjustable support device to support a box spring mattress or an upholstered bed which includes the electric motor dual drive according to claim 1.
